(19) United States
(12) Patent Application Publication
(10) Pub. No.: US 2010/0072283 A1
(43) Pub. Date: Mar. 25, 2010

(54) HOLDER FOR SMALL IDENTIFICATION CARD

(76) Inventors: Simon Phillips, York (GB); Stephen Marshall-Rees, Hampshire (GB); Benjamin Biswell, Hampshire (GB)

Correspondence Address: BUCKLEY, MASCHOFF & TALWALKAR LLC, 50 LOCUST AVENUE, NEW CANAAN, CT, 06840, US

(21) Appl. No.: 12/562,624

(22) Filed: Sep. 18, 2009

Related U.S. Application Data
(60) Provisional application No. 61/099,635, filed on Sep. 24, 2008.

(51) Int. Cl. G06K 7/00

(52) U.S. Cl. 235/486; 235/492; 235/495

(57) ABSTRACT

An article of manufacture includes a plastic substrate. The substrate has a first side and a second side that is opposite to the first side, with an adhesive material on the first side of the substrate. The article of manufacture further includes a ferrite layer on the second side of the plastic substrate. In addition, the article of manufacture includes a top sheet formed of plastic. The top sheet is joined to the substrate to form a pouch between the top sheet and the ferrite layer. The pouch is shaped and sized to hold a contactless integrated circuit (IC) identification card that has no more than half of a planar extent defined for the standard ID-1 identification card. The top sheet has a thickness of not more than about 0.2 mm.

### CROSS-REFERENCE TO RELATED APPLICATION

This application claims the benefit of co-pending U.S. provisional patent application Ser. No. 61/099,635, filed Sep. 24, 2008, which provisional patent application is incorporated herein by reference.

### BACKGROUND

Prior U.S. patent application Ser. No. 11/829,165, filed Jul. 27, 2007, entitled “Removably Securing Small Contactless Payment Card to Electronic Device”, has a common inventor with this provisional patent application, and is incorporated herein by reference. The '165 application discloses a holder for securing a small RFID (radio frequency identification) IC (integrated circuit) identification card (e.g., a contactless payment card) to an electronic device such as a mobile telephone. The present disclosure is concerned with characteristics that may be advantageously incorporated in such a holder, and techniques for manufacturing such a holder.

To quote from the '165 application:

“It is well known to provide contactless payment cards in the standard ID-1 geometry (substantially 85.6×54 mm in planar extent). Such cards resemble conventional credit and debit cards in size and shape, and allow account holders to access debit or credit card accounts to pay for transactions by wireless communication between the contactless payment cards and proximity readers included in point of sale (POS) terminals.

“Because of the wireless communication capability of these cards, it is feasible to enhance their convenience by shrinking their size, to perhaps one-half or one-third or less of the planar extent of the standard ID-1 geometry. In this reduced size, a contactless payment card may be carried as a fob on a key ring.

“According to certain prior art proposals, it has been suggested that small contactless payment cards be integrated with handheld electronic devices such as mobile telephones. In one such proposal, the housing of a mobile telephone is configured to include one or more slots shaped and sized to receive small contactless payment cards. However, this approach requires coordination and cooperation with manufacturers of mobile telephones and/or with mobile telephone network operators. Also, if a slot or slots of a certain size are included in the mobile telephone housing, small contactless cards of other sizes would not be compatible with the mobile telephone. Still further, there may be significant added cost in modifying the mobile telephone design to accommodate contactless card slots.

“In another prior art proposal, an adhesive layer is added to the rear of a contactless payment card, which may take the form of a somewhat flexible self-adhesive label. The card/label can then be adhered to the rear surface of a mobile telephone. One disadvantage with this approach may arise if the account holder wishes to replace the mobile telephone after attaching the payment card/label thereto. It may be difficult to remove the card/label from the mobile telephone housing, and may be impossible to attach the card/label to the cardholder's new mobile telephone. Also, if the account holder desires to change payment cards, the problem of removing the card/label from the mobile telephone housing again arises, and such removal may leave an adhesive residue on the mobile telephone housing. Still another disadvantage may arise if the account holder wishes to temporarily lend his/her mobile telephone to another individual, but does not wish to entrust his/her payment card to the individual.

“Another possible disadvantage of the latter approach is that the layer of adhesive material on the card/label and/or the flexibility of the card/label may make it difficult to perform personalization processing on the card/label with conventional personalization equipment. Consequently, the cost of personalizing the card/label may be increased.”

Like the card holder disclosed in the '165 application, the card holder disclosed herein may overcome many, if not all, of the disadvantages described in the preceding paragraphs.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 is an exploded view which shows components from which a holder for a small contactless IC card may be assembled in accordance with aspects of the present invention.

FIGS. 2A-2C are somewhat schematic side cross-sectional views that illustrate a card-retention feature that may be included the card holder of FIG. 1, and also illustrate a process by which the IC card may be inserted into the holder.

FIG. 3 is a partial side cross-sectional view showing additional details of the card holder with the IC card enclosed within.

FIG. 4 is a schematic plan view of an example of the IC card seen in FIGS. 2A-2C.

FIG. 5 is a flow chart that illustrates a process for manufacturing the card holder of FIG. 1.

FIG. 6 is a flow chart that illustrates a process that may be performed by a user of the card holder and IC card.

FIG. 7 schematically illustrates some communication aspects of a purchase transaction performed using a contactless payment card that has been secured to a mobile telephone.

FIG. 8 schematically illustrates some physical aspects of the purchase transaction of FIG. 7.

### DETAILED DESCRIPTION

In general, and for the purpose of introducing concepts of embodiments of the present invention, a holder for a small contactless payment card is provided in the form of a self-adhesive label. The card holder may be attached to a handheld electronic device like a mobile telephone, and then the contactless payment card may be inserted into the holder to secure the contactless payment card to the electronic device.

To obtain a desirably low profile for the holder, it may be constructed from a plastic substrate and a thinner top sheet that is bonded to the substrate to form a pouch into which the payment card is inserted. By vacuforming the top sheet, a very thin thickness dimension of the top sheet may be obtained. The substrate may be formed by injection molding to obtain a desired degree of structural stability for the holder.

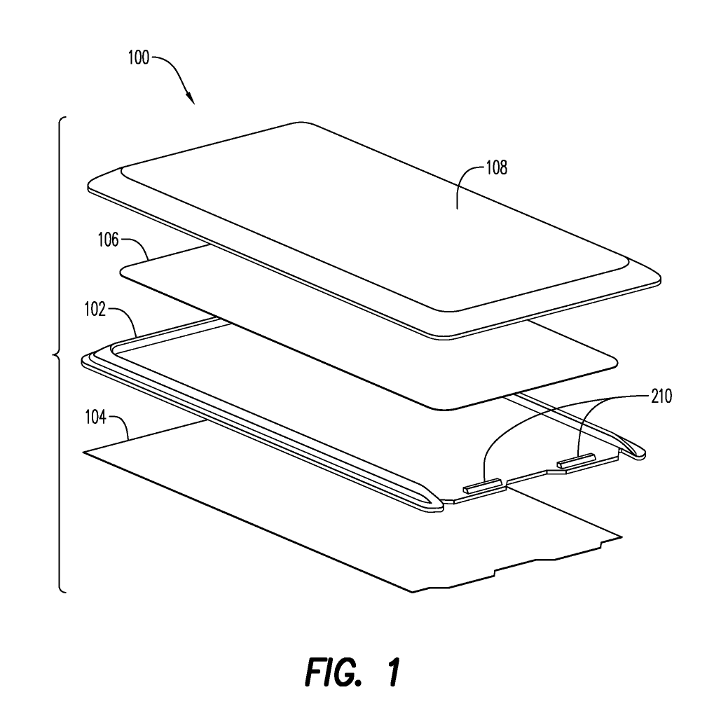

FIG. 1 shows in exploded form four components from which an identification card holder 100 may be formed. The four components include a plastic substrate or tray 102 that may be plastic and formed by injection molding. The substrate 102 is the major structural component of the holder 100. On the lower side or surface of the substrate 102, an adhesive layer 104 is provided to allow the holder 100 to be secured to a mobile telephone or other electronic device. Although not shown in the drawing, upon completion of the manufacturing process and during transport and handling and prior to use, an additional peelable sheet may be provided to cover the adhesive layer until such time as the user wishes to attach the holder 100 to the electronic device.

A ferrite layer 106 is provided on the upper side or surface of the substrate 102. The ferrite layer may serve to shield the identification card from interference from the electronic components of the phone/electronic device to which the card is to be secured.

The holder 100 also includes a top sheet 108. The top sheet 108 may be formed of plastic and may be formed by vacuum forming, which is a known fabrication technique that is also referred to as “vacuforming”. In vacuforming, which is a type of thermoforming, a sheet of plastic is heated to a forming temperature, stretched onto or into a single-surface mold, and held against the mold by applying vacuum between the mold surface and the sheet. Another type of thermoforming, which alternatively may be used to form the top sheet 108, is referred to as “pressure forming”.

In fabricating the holder 100, the top sheet 106 may be bonded to the substrate 102 by, e.g., welding or by a suitable adhesive so as to form a pouch between the top sheet 108 and the substrate 102. The pouch may be of a shape and size that is suitable for housing a small RFID identification card such as those described in the above-referenced '165 patent application.

Because the top sheet 108 is formed via a process of vacuforming, the top sheet may be thinner than would be possible if injection molding were employed to form it. Consequently, the over-all thickness of the holder 100, when the identification card (not shown in FIG. 1) is present within the holder 100, may be less than about 2 mm. The present inventors consider it desirable that the holder with card enclosed not be thicker than 2 mm in order that the holder and card not interfere with handling and carrying of the electronic device to which the holder and card are attached.

Additional details concerning construction of the holder 100 will be described below.

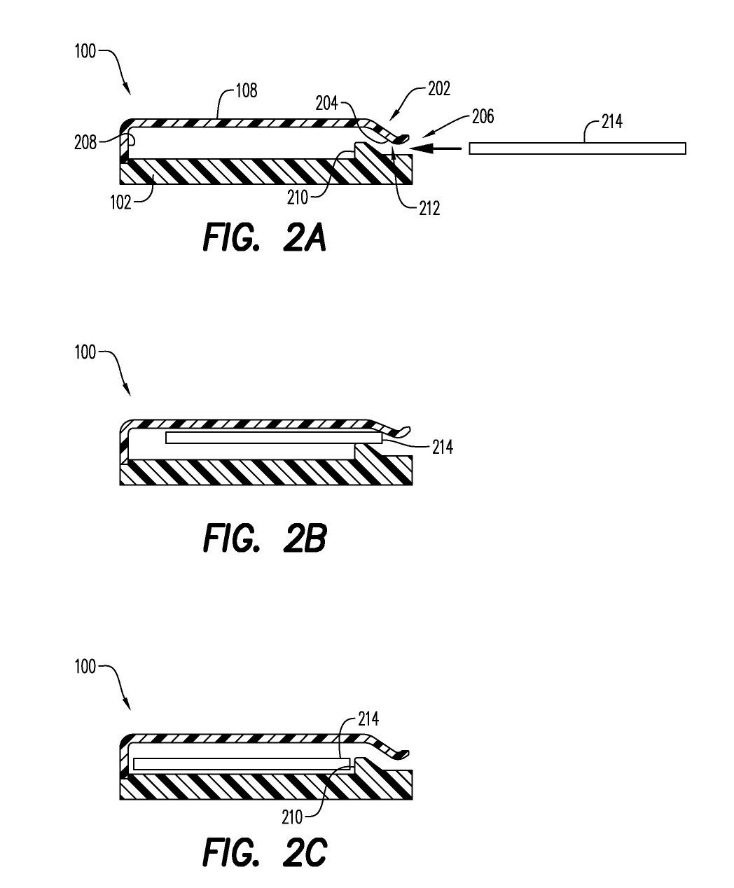

FIGS. 2A-2C are somewhat schematic side cross-sectional views that illustrate a card-retention mechanism that may be included the card holder 100, and also illustrate a process by which the IC card may be inserted into the holder 100. (To simplify the presentation of these drawings, the ferrite layer and the adhesive layer are omitted.) The IC card is indicated by reference numeral 214 in FIGS. 2A-2C. The card retention mechanism is generally indicated by reference numeral 202 in FIG. 2A. The card retention mechanism 202 may include a leaf sprung feature 204 formed in the top sheet 108 at the opening 206 of the pouch 208 formed in the holder 100. The card retention mechanism 202 further includes one or more barbs 210 (also visible in FIG. 1) formed on the substrate 102 at the opening 206 of the pouch 208.

In an operation in which the identification card is inserted into the pouch 208 of the holder 100, an angled surface 212 on the leaf sprung feature 204 is used to push the identification card 214 past the barbs 210 during insertion of the card 214 into the pouch 208, as seen from FIG. 2B. In some embodiments, once the trailing edge of the card 214 is pushed far enough for the angled surface 212 to contact the trailing edge of the card 214, spring action by the top sheet 108 may be sufficient, without further force imparted by the user, to urge the card 214 to its fully enclosed home position as illustrated in FIG. 2C. FIG. 2C also shows that once the card 214 is past the barbs 210, the barbs 210 secure the card 214 in place inside the holder 100.

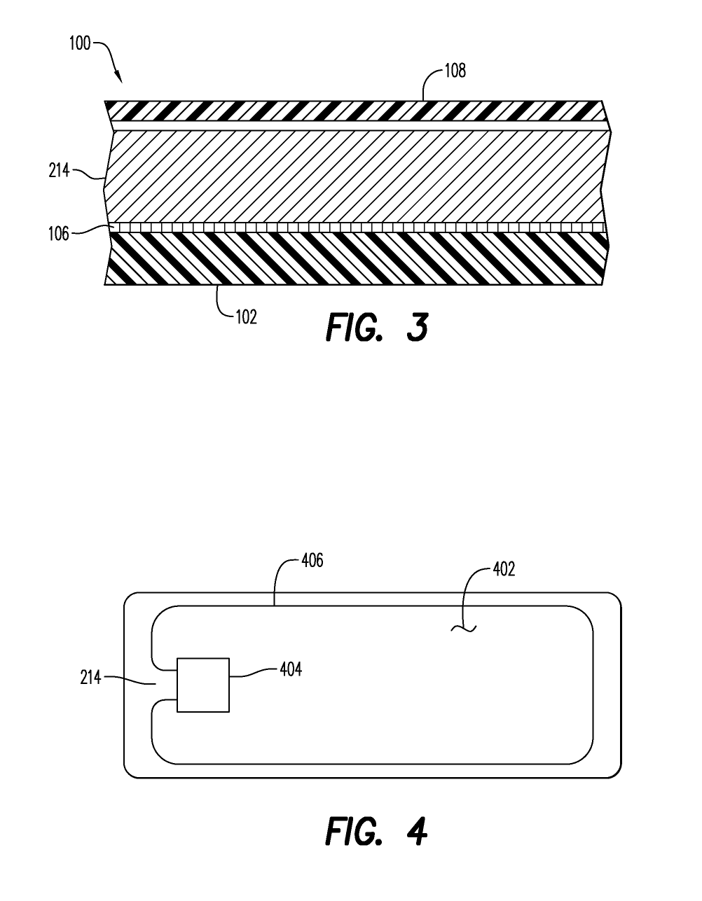

FIG. 3 is a partial side cross-sectional view showing additional details of the card holder 100 with the IC card 214 enclosed within. FIGS. 2A-2C are schematic at least in the sense that those drawings are not necessarily to scale, and may not reflect the relative thickness of the card 214 and of the components of the card holder 100. On the other hand, FIG. 3, while not necessarily entirely to scale, may be considered a somewhat more accurate depiction of relative thicknesses of the card 214 and of the components of the card holder. Thus, the substrate 102 may have a thickness of substantially 0.5 mm; the ferrite layer 106 may be about 0.1 mm thick; the card 214 may be about 0.8 mm thick, and the top sheet 108 may be about 0.2 mm thick. A layer of space schematically indicated at 302 represents a degree of clearance provided by the shape of the top sheet 108 to facilitate insertion of the card 214 into the holder 100. The resulting total thickness of the holder 100, with the card 214 enclosed therein, is about 1.9 mm, as measured at a central point in the planar extent of the holder 100. With the card 214 enclosed within the holder 100, the holder 100 together with the card 214 may be referred to as a “contactless IC card assembly”.

FIG. 4 is a schematic plan view of an example of the IC card 214.

As seen from FIG. 4, the IC card 214 includes a card-shaped body 402 (e.g., laminated from layers of plastic) in which an RFID (radio frequency identification) chip 404 (IC or integrated circuit) is embedded. An antenna 406 is embedded in the card-shaped body 402 and runs along the periphery of the card-shaped body 402. The antenna 406 is coupled to the RFID chip 404 to allow the RFID chip 404 to receive interrogation signals from proximity reader devices included in POS terminals. The antenna 406 also allows the RFID chip to transmit payment card account information and other information to the POS terminals. The card 214 may be constructed and may operate in accordance with conventional practices. For purposes of illustration, the RFID chip and antenna are shown in FIG. 4, but in practical examples of the card 214 the card body may be formed largely of opaque plastic and the RFID chip and antenna may be embedded in the opaque plastic so as not to be visible. Instead, the card 214 may display branding information such as one or more logos of the issuing bank and of a payment card association, and also may display information, such as account number (or a portion of the account number) and account holder's name, that is specific to the particular card.

In some embodiments, the dimensions of the card 214 (and of its card-shaped body) may be substantially 1.88 in. by 1.0 in. by 0.8 mm. (It will be noted that FIG. 4 is not necessarily presented to scale.)

Reference was made above to the process of “personalizing” the payment card. As is familiar to those who are skilled in the art, during personalization, card specific information is wirelessly written into the card's RFID chip, and may also be printed on the card. In accordance with prior proposals, the process of personalization may be simplified by initially providing the card blank as part of an ID-1 sized assembly that includes scoring or the like to define the card within the ID-1 sized footprint of the assembly. The ID-1 sized assembly may then be processed for purposes of personalizing the card blank using the same standard types of personalization equipment conventionally used to personalize ID-1 sized contactless payment cards. After personalization, the assembly may be sent to the prospective user, who detaches the card from the assembly.

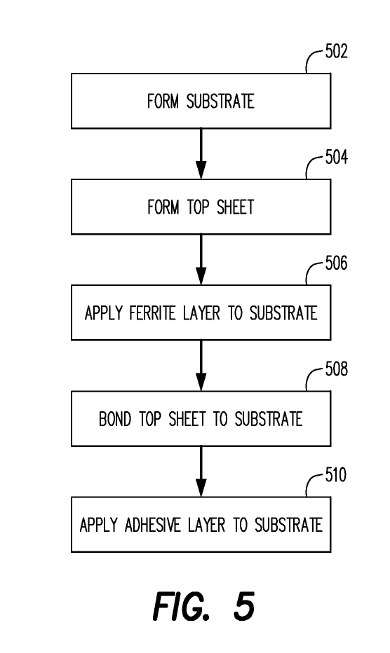

FIG. 5 is a flow chart that illustrates a process for manufacturing the card holder 100.

At 502 in FIG. 5, the substrate 102 is formed, preferably by injection molding to obtain structural stability and to form the card retention barbs 210 seen in FIGS. 2A-2C. The material of which the substrate 102 is formed may be, for example, acrylonitrile butadiene styrene polycarbonate (ABS PC), although other types of plastic may alternatively be used. The substrate 102 may be formed with a suitable bead (not separately shown) in accordance with conventional practices to facilitate the welding step referred to below.

At 504 in FIG. 5, the top sheet 108 is formed, by vacuforming or pressure forming, to obtain the desired very thin thickness dimension of the sheet. The top sheet 108 may be formed, for example, from polyethylene terephthalate (PETE) or polycarbonate. Typically, the top sheet 108 is formed of a different material from the substrate 102. As is familiar to those who are skilled in the art, trimming of the top sheet 108 may be required after the forming operation itself. Because of the costs entailed in the trimming step, those of ordinary skill in the art would not normally employ vacuforming for a piece like the top sheet 108, but the present inventors propose doing so because of their recognition of the benefits of reducing the over-all profile of the holder 100. Step 504 should be understood to include any necessary trimming.

The top sheet 108 may be substantially more flexible than the substrate 102. To express the same idea in other words, at the time step 504 is complete, the top sheet 108 may have a shear modulus that is substantially less than the shear modulus that the substrate 102 has upon completion of step 502.

At 506, the above-mentioned ferrite layer 106 is applied to the top surface of the substrate 102.

At 508, the top sheet 108 is bonded to the substrate 102 so that the pouch 208 (FIG. 2A) is formed between the ferrite layer 106 and the top sheet 108. The pouch 208, as mentioned above, is for holding the small IC card 214 shown in FIGS. 2A-2C. The bonding step is preferably performed by ultrasonically welding the top sheet 108 to the substrate 102.

At 510 in FIG. 5, the adhesive layer 104 (FIG. 1) is applied to the lower surface of the substrate 102, and the above-mentioned peelable cover sheet for the adhesive layer is also put in place.

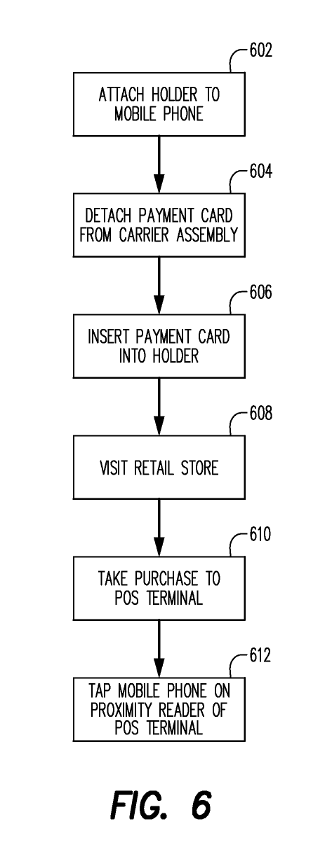

FIG. 6 is a flow chart that illustrates a process that may be performed by a user of the card holder and IC card.

At 602 in FIG. 6, the user attaches a card holder to his/her mobile telephone (reference numeral 802, FIG. 8, discussed below; card holder not separately depicted in FIG. 8). The card holder may be provided in accordance with the card holder 100 depicted in FIGS. 1-2C and discussed above. From previous discussion, it will be appreciated that the card holder may be attached to the mobile telephone by an adhesive layer that is provided on a surface of the card holder (e.g., on the lower surface of the card holder substrate referred to above).

At 604 in FIG. 6, the user detaches the small contactless payment card from a carrier/assembly that has been sent by the card issuer to the user. The card may be provided in accordance with the card 214 depicted in FIG. 4 and/or as described in conjunction with FIG. 4.

At 606 in FIG. 6, the user inserts the contactless payment card into the pouch of the card holder that has been attached to the mobile telephone. In this way the payment card is secured to the mobile telephone.

At 608, the user takes the mobile telephone, with card holder and payment card attached, with him/her while he/she visits a retail store. At 610, the user makes a selection of merchandise at the store and presents the merchandise for purchase at a POS terminal in the store. After the sales clerk has entered the items to be purchased into the POS terminal (e.g., by scanning barcodes on the merchandise), the user effects payment (612 in FIG. 6) for the transaction by tapping the mobile telephone (e.g., with the payment card side down) on the proximity reader component of the POS terminal. With the payment card thus or otherwise brought into proximity with the reader, wireless communications are exchanged between the payment card and the reader. In this manner, the user's payment card account number is communicated to the POS terminal from the payment card and is used to authorize and settle the purchase transaction.

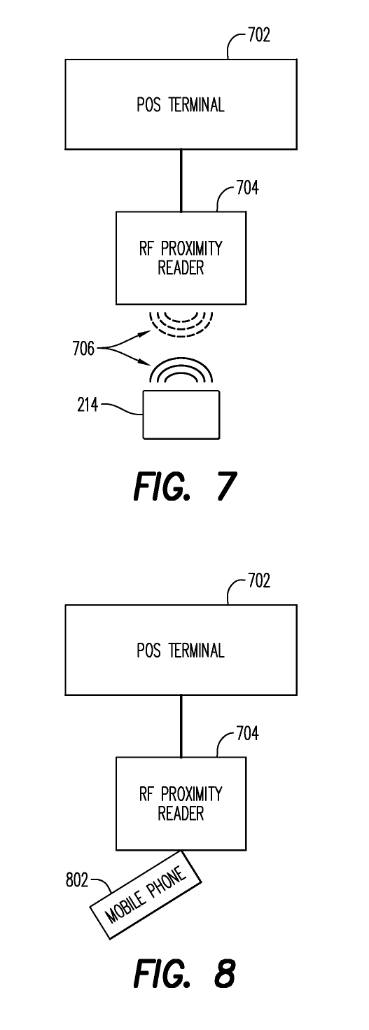

FIG. 7 schematically illustrates some communication aspects of the purchase transaction. The POS terminal is represented at block 702, and block 704 represents the proximity reader interfaced to or incorporated in the POS terminal 702. The payment card is indicated at 214, and the wireless communication between the payment card 214 and the proximity reader 704 is indicated at 706.

FIG. 8 schematically illustrates some physical aspects of the purchase transaction. As in FIG. 7, the POS terminal 702 and its associated proximity reader 704 are shown. The mobile phone 802 is also shown in proximity to the proximity reader 704. It is assumed that (pursuant to the process illustrated in FIG. 6) the mobile phone has the above described card holder (not shown in FIG. 8) attached to the mobile phone and the payment card (not shown in FIG. 8) is secured to the mobile phone by having been inserted into the pouch (not shown) of the card holder.

In embodiments described up to this point, the card holder has been attached to a mobile phone. More generally, however, the card holder may be attached to any type of electronic device, such as a handheld music player (e.g., an iPod) or a personal digital assistant (PDA; including, e.g., devices sold under the name “BlackBerry”), a pager, etc.

In some embodiments, the card retention mechanism 202 (FIGS. 2A-2C) may be dispensed with, and friction alone may be sufficient to retain the card in place within the holder.

The flow charts and descriptions thereof herein should not be understood to prescribe a fixed order of performing the method steps described therein. Rather the method steps may be performed in any order that is practicable. In some embodiments, for example, the payment card may be inserted into the card holder before the card holder is attached to the electronic device.

As the term is used herein and in the appended claims, a pouch is “shaped and sized” to hold a card if the pouch has dimensions such that the card fits inside the pouch but would not fit if the card were substantially larger than it is.

In accordance with normal usage, the abbreviation “mm” refers to millimeters.

A card should be understood to have three mutually orthogonal dimensions, where the “length” dimension is the longest dimension of the card, the “thickness” dimension is the smallest dimension of the card, and the “height” dimension is less than the length dimension and more than the thickness dimension.

The term “planar extent” refers to the amount of area in a plane occupied by a generally planar object. For example, the 3.37 in. by 2.125 in. standard ID-1 card has a planar extent of about 7.16 square inches (=3.37×2.125).

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. An article of manufacture, comprising:
a plastic substrate, having a first side and a second side opposite the first side, with an adhesive material on the first side of the substrate;
a ferrite layer on said second side of said plastic substrate; and
a top sheet formed of plastic and joined to the substrate to form a pouch between said plastic sheet and said ferrite layer, the pouch shaped and sized to hold a contactless integrated circuit (IC) identification card that has no more than half of a planar extent defined for a standard ID-1 identification card, the top sheet having a thickness of not more than about 0.2 mm.

2. The article of manufacture of claim 1, wherein:
the top sheet is formed of polyethylene terephthalate or polycarbonate; and
the plastic substrate is formed of acrylonitrile butadiene styrene polycarbonate.

3. The article of manufacture of claim 1, wherein:
the pouch is shaped and sized to hold a contactless IC identification card having a thickness of substantially 0.8 mm.

4. The article of manufacture of claim 3, wherein:
the pouch is shaped and sized to hold a contactless IC identification card having a planar extent of less than one-third of the planar extent defined for the standard ID-1 identification card.

5. The article of manufacture of claim 4, wherein:
the pouch is shaped and sized to hold a contactless IC identification card having a length of substantially 1.88 in. and a height of substantially 1.0 in.

6. A method comprising:
forming a plastic substrate having a first side and a second side opposite to the first side;
forming a top sheet of a plastic material, the top sheet having a thickness of not more than about 0.2 mm;
applying an adhesive layer to the first side of the plastic substrate;
applying a ferrite layer to the second side of the plastic substrate; and
bonding the top sheet to the plastic substrate so as to form a pouch between the top sheet and the ferrite layer.

7. The method of claim 6, wherein:
the top sheet is formed by thermo-forming; and
the plastic substrate is formed by injection molding.

8. The method of claim 6, wherein:
the top sheet is formed of polyethylene terephthalate or polycarbonate; and
the plastic substrate is formed of acrylonitrile butadiene styrene polycarbonate.

9. The method of claim 6, wherein the bonding step includes ultrasonically welding the top sheet to the plastic substrate.

10. The method of claim 6, wherein the pouch is shaped and sized to hold a contactless integrated circuit (IC) identification card that has no more than half of a planar extent defined for a standard ID-1 identification card.

11. The method of claim 10, wherein:
the pouch is shaped and sized to hold a contactless IC identification card having a thickness of substantially 0.8 mm.

12. The method of claim 11, wherein:
the pouch is shaped and sized to hold a contactless IC identification card having a planar extent of less than one-third of the planar extent defined for the standard ID-1 identification card.

13. The method of claim 12, wherein:
the pouch is shaped and sized to hold a contactless IC identification card having a length of substantially 1.88 in. and a height of substantially 1.0 in.

14. The method of claim 6, wherein:
upon completion of the step of forming the top sheet, the top sheet has a shear modulus that is substantially less than a shear modulus that the plastic substrate has upon completion of the step of forming the plastic substrate.

15. The method of claim 6, wherein:
the plastic substrate has a thickness of substantially 0.5 mm.

16. A contactless integrated circuit (IC) card assembly, comprising:
a holder that includes a pouch; and
a contactless IC card inserted in the pouch and substantially entirely enclosed within the pouch;
wherein the assembly has a total thickness of less than 2 mm, said total thickness measured at a central point of a planar extent of said assembly.

17. The contactless IC card assembly of claim 16, wherein:
the pouch is formed between a top sheet of the holder and a ferrite layer formed on a plastic substrate portion of the holder;
the top sheet has a thickness that is not in excess of about 0.2 mm;
the contactless IC card has a thickness of about 0.8 mm;
the ferrite layer has a thickness of about 0.1 mm; and
the plastic substrate portion of the holder has a thickness of about 0.5 mm.

18. The contactless IC card assembly of claim 17, wherein the pouch is shaped and sized to hold a contactless integrated circuit (IC) identification card that has no more than half of a planar extent defined for a standard ID-1 identification card.

19. The contactless IC card assembly of claim 18, wherein:
the pouch is shaped and sized to hold a contactless IC identification card having a planar extent of less than one-third of the planar extent defined for the standard ID-1 identification card.

20. The contactless IC card assembly of claim 19, wherein the pouch is shaped and sized to hold a contactless IC identification card having a length of substantially 1.88 in. and a height of substantially 1.0 in.
